(19) United States
(12) Patent Application Publication
(10) Pub. No.: US 2024/0378484 A1
(43) Pub. Date: Nov. 14, 2024

(54) Method for Retraining with Auto-Validation of Machine Learning Models

(71) Applicant: Google LLC, Mountain View, CA (US)

(72) Inventors: Walter Bogorad, Danville, CA (US); Ronald Rong Yang, San Jose, CA (US); Alexander Troesch, Mountain View, CA (US); Bavin Amenya Ondieki, Mountain View, CA (US); Yousef Khaled Nassar, Mountain View, CA (US)

(21) Appl. No.: 18/288,442

(22) PCT Filed: Sep. 13, 2022
(86) PCT No.: PCT/US2022/043273

§ 371 Date: Oct. 26, 2023

(51) Int. Cl. G06N 20/00

(52) U.S. Cl. CPC G06N 20/00

(57) ABSTRACT

Aspects of the disclosure are directed to retraining an ensemble machine learning model. The ensemble model can include a base model and an overlay model. The base model can be trained on an older dataset, validated, and manually verified. The overlay model can be trained on a newer dataset and automatically validated. A combination of base model predictions and overlay model predictions, with bias towards the base model predictions, can form ensemble model predictions. A model weight for optimizing the ensemble model can determine the bias, as well as indicate that the overlay model contributes too much or too little to the ensemble model.

### BACKGROUND

Machine learning models in a production setting can experience degradation of performance over time because of changes in data distribution. Therefore, these machine learning models should be periodically retrained on more recent data. However, retraining in some production settings, such as high impact systems that can directly affect revenue, cost, and/or trust in the machine learning model, can require manual and labor-intensive validation and/or verification. This problem can be aggravated if the machine learning model is a neural network because neural networks can have unstable predictions based on different initializations of weights.

### BRIEF SUMMARY

Aspects of the disclosure are directed to retraining a machine learning model as an ensemble model. The ensemble model can include a base model trained on an older dataset, validated, and manually verified and can include an overlay model trained on a newer dataset and automatically validated. Ensemble model predictions can be based on combinations of the base model predictions and the overlay model predictions, with bias towards the base model predictions. A model weight for optimizing the ensemble model can determine the amount of bias, as well as indicate that the overlay model contributes too much or too little to the ensemble model.

An aspect of the disclosure provides for a computer-implemented method for retraining a machine learning model. The method includes generating, with one or more processors, an ensemble model. The ensemble model includes a base model and an overlay model, where the base model has been trained using a first dataset. The method further includes training, with the one or more processors, the overlay model with a training dataset, where the training dataset is a first subset of a second dataset that is newer than the first dataset. The method also includes validating, with the one or more processors, the trained overlay model with a test dataset using a plurality of metrics, where the test dataset is a second subset of the second dataset. The method further includes determining, with the one or more processors and based on the plurality of metrics, an amount of bias to provide to the base model compared to the overlay model when performing predictions using the ensemble model. The method also includes performing, with the one or more processors, a prediction using the ensemble model based on a combination of a prediction from the base model and a prediction from the overlay model with the determined amount of bias towards the prediction from the base model.

In an example, the method further includes training, with the one or more processors, the base model with a base model training dataset, wherein the base model training dataset is a first subset of the first dataset. In another example, the method further includes validating, with the one or more processors, the base model with a base model test dataset, where the base model test dataset is a second subset of the first dataset; and manually verifying the base model with the base model test dataset of the first dataset.

In yet another example, the plurality of metrics includes classification performance. In yet another example, determining the amount of bias further includes determining a maximum classification performance of the ensemble model in a search interval using a search method. In yet another example, the search interval includes a starting weight value to a weight value of 1, the starting weight value being greater than 0.5.

In yet another example, the method further includes determining, with the one or more processors, that the determined amount of bias is within a range within the search interval where both the overlay model and base model each contribute above a threshold amount to the ensemble model predictions. In yet another example, the method further includes determining, with the one or more processors, that the determined amount of bias is within a range within the search interval where the overlay model contributes below a threshold amount to the ensemble model predictions; and retraining, with the one or more processors, the overlay model with the second dataset. In yet another example, the method further includes determining, with the one or more processors, that the determined amount of bias is within a range within the search interval where the base model contributes below a threshold amount to the ensemble model predictions; and replacing, with the one or more processors, the base model.

In yet another example, the plurality of metrics comprises stability. In yet another example, the method further includes determining, with the one or more processors, ensemble model predictions are within a threshold compared to predictions from a previous model such that the ensemble model is pushed to production.

Another aspect of the disclosure provides for a system including one or more processors; and one or more storage devices coupled to the one or more processors and storing instructions that, when executed by the one or more processors, cause the one or more processors to perform operations for retraining a machine learning model. The operations include generating an ensemble model. The ensemble model includes a base model and an overlay model, where the base model has been trained using a first dataset. The operations further include training the overlay model with a training dataset, where the training dataset is a first subset of a second dataset that is newer than the first dataset. The operations also include validating the trained overlay model with a test dataset using a plurality of metrics, where the test dataset is a second subset of the second dataset. The operations further include determining, based on the plurality of metrics, an amount of bias to provide to the base model compared to the overlay model when performing predictions using the ensemble model. The operations also include performing a prediction using the ensemble model based on a combination of a prediction from the base model and a prediction from the overlay model with the determined amount of bias towards the prediction from the base model.

In an example, the operations further include training the base model with a base model training dataset, where the base model training dataset is a first subset of the first dataset. In another example, the operations further include validating the base model with a base model test dataset, where the base model test dataset is a second subset of the first dataset; and manually verifying the base model with the base model test dataset of the first dataset.

In yet another example, the plurality of metrics includes classification performance. In yet another example, determining the amount of bias further includes determining a maximum classification performance of the ensemble model in a search interval using a search method. In yet another example, the search interval includes a starting weight value to a weight value of 1, the starting weight value being greater than 0.5.

In yet another example, the operations further include determining that the determined amount of bias is within a range within the search interval where both the overlay model and base model each contribute above a threshold amount to the ensemble model predictions. In yet another example, the operations further include determining that the determined amount of bias is within a range within the search interval where the overlay model contributes below a threshold amount to the ensemble model predictions; and retraining the overlay model with the second dataset. In yet another example, the operations further include determining that the determined amount of bias is within a range within the search interval where the base model contributes below a threshold amount to the ensemble model predictions; and replacing the base model.

In yet another example, the plurality of metrics includes stability. In yet another example, the operations further include determining ensemble model predictions are within a threshold compared to predictions from a previous model such that the ensemble model is pushed to production.

Yet another aspect of the disclosure provides for a computer readable medium for storing instructions that, when executed by one or more processors, cause the one or more processors to perform operations for retraining a machine learning model. The operations include generating an ensemble model. The ensemble model includes a base model and an overlay model, where the base model has been trained using a first dataset. The operations further include training the overlay model with a training dataset, where the training dataset is a first subset of a second dataset that is newer than the first dataset. The operations also include validating the trained overlay model with a test dataset using a plurality of metrics, where the test dataset is a second subset of the second dataset. The operations further include determining, based on the plurality of metrics, an amount of bias to provide to the base model compared to the overlay model when performing predictions using the ensemble model. The operations also include performing a prediction using the ensemble model based on a combination of a prediction from the base model and a prediction from the overlay model with the determined amount of bias towards the prediction from the base model.

In an example, the operations further include training the base model with a base model training dataset, where the base model training dataset is a first subset of the first dataset. In another example, the operations further include validating the base model with a base model test dataset, where the base model test dataset is a second subset of the first dataset; and manually verifying the base model with the base model test dataset of the first dataset.

In yet another example, the plurality of metrics includes classification performance. In yet another example, determining the amount of bias further includes determining a maximum classification performance of the ensemble model in a search interval using a search method. In yet another example, the search interval includes a starting weight value to a weight value of 1, the starting weight value being greater than 0.5.

In yet another example, the operations further include determining that the determined amount of bias is within a range within the search interval where both the overlay model and base model each contribute above a threshold amount to the ensemble model predictions. In yet another example, the operations further include determining that the determined amount of bias is within a range within the search interval where the overlay model contributes below a threshold amount to the ensemble model predictions; and retraining the overlay model with the second dataset. In yet another example, the operations further include determining that the determined amount of bias is within a range within the search interval where the base model contributes below a threshold amount to the ensemble model predictions; and replacing the base model.

In yet another example, the plurality of metrics includes stability. In yet another example, the operations further include determining ensemble model predictions are within a threshold compared to predictions from a previous model such that the ensemble model is pushed to production.

### BRIEF DESCRIPTION OF THE DRAWINGS

FIG. 1 depicts a block diagram of an example ensemble model generation system according to aspects of the disclosure.

FIG. 2 depicts an example time diagram of model training and retraining based on model classification performance degradation according to aspects of the disclosure.

FIG. 3 depicts a flow diagram of an example process for retraining a machine learning model using an ensemble model according to aspects of the disclosure.

FIG. 4 depicts a block diagram of an example environment for retraining machine learning models using an ensemble model according to aspects of the disclosure.

### DETAILED DESCRIPTION

Generally disclosed herein are implementations for retraining a machine learning model with automatic validation. The retrained machine learning model can correspond to: an ensemble model, including a base model trained on an older dataset from an older time frame, validated, and manually verified; and an overlay model trained on a newer dataset from a newer time frame, e.g., more recent than the older time frame, and automatically validated. The base model can be trained with a base model training dataset that is a first subset of the older dataset and can be validated with a base model test dataset that is a second subset of the older dataset. The overlay model can be trained with an overlay model training dataset that is a first subset of the newer dataset and can be validated with an overlay model test dataset that is a second subset of the newer dataset.

Predictions from the ensemble model can correspond to combinations of the base model predictions and the overlay model predictions, with an amount of bias towards the base model predictions. The amount of bias can correspond to how much influence the base model predictions have on the ensemble model prediction. The amount of bias can be determined by a model weight that corresponds to a parameter for optimizing the ensemble model. The model weight can also indicate when the overlay model does not contribute enough or contributes too much to the ensemble model, as well as indicate when the base model starts underperforming such that it should be replaced.

Retraining the ensemble model can be implemented in a spam detection domain to protect advertising metrics, such as advertising revenue, by identifying invalid traffic and filtering it out. Invalid traffic can include bot traffic, pay-to-click traffic, or other kinds of abusive traffic. Spam detection can identify publishers of invalid traffic as fraudulent, so that they can be terminated from the ad network or have ads stopped being served to them. Spam detection can also identify publishers of a mixture of invalid and organic traffic, so that the invalid traffic can be filtered out while the organic traffic can be allowed. In this way, the various aspects of the present disclosure can be applied to such technical fields as detection of fraudulent activity within an advertising context. It is important that machine learning models, such as the ensemble model, perform correctly and accurately when applied to the context of fraudulent activity detection, so that fraudulent traffic can be accurately filtered out whilst valid and legitimate traffic is allowed. The disclosed systems and methods of retraining an ensemble model therefore provide a technical effect of enabling a more accurate fraud detection.

Retraining the ensemble model can also be implemented in other domains where there is a high stake of making mistakes, where model validation involves manual reviews, and/or where data fluctuates over time. For example, other domains can include identifying financial fraud, monitoring safety of engineering constructions, and computer security for sensitive enterprises. The disclosed systems and methods therefore provide improved accuracy for machine learning models for a wide range of technical applications.

For the overlay models, the newer dataset can be split into training and test datasets. The overlay model is trained with the training dataset and automatically validated by computing a plurality of metrics on the test dataset. The plurality of metrics can include classification performance and stability.

Classification performance can correspond to how well a machine learning model performs classification using a test dataset. Classification performance can be determined by area under the curve receiver operating characteristic (AUCROC), area under the curve precision recall (AUCPR), or F-score, as examples. Classification performance of the overlay model should be on par with the base model, where how far the overlay model can diverge in classification performance from the base model is domain specific. For example, in the spam detection domain, AUCPR for the base model can be 0.53 and for the overlay model can be 0.49, while the ensemble model can have a higher AUCPR, such as 0.55. It should be noted that these divergences of classification performance are merely examples, and as long as the ensemble model has a higher classification performance than the base model or a previous model in production, the ensemble model can be pushed to production. Being pushed to production can include being deployed for real-world use as a web service, as offline batch prediction, or as embedded on edge/mobile devices. In other words, being pushed to production means that the ensemble model is used in real-world settings for use in the intended application. For example, when the ensemble model is pushed to production, this may mean that the ensemble model is used as a web-service or embedded on a user device to identify and filter fraudulent online activity.

Since the base model is fully trained, including manual verification as opposed to just automatic validation, the ensemble model predictions should be biased towards the base model predictions, even though the overlay model is trained on newer data. An optimal model weight corresponding to the optimal amount of bias to give to the base model can be determined by determining a maximum classification performance of the ensemble model in a search interval from a starting weight value to 1 using a search method, such as a grid search or a generic line search with step 0.05. The step size is domain specific and can range from 0.01 to 0.1 depending on sensitivity of classification performance to the weight value. The starting weight value can control a minimum bias of the base model and can be domain specific. For example, in the spam detection domain, the starting weight value can be 0.7. The starting weight value can be larger than 0.5 to provide more bias towards the base model.

If the optimal weight is within a range within the search interval and is less than 1, the optimal weight indicates that the overlay model and base models both significantly contribute to the ensemble model predictions. Thus, the ensemble model can be a good candidate to be pushed to production. In the spam detection domain, the optimal weight can be less than or equal to 0.95. If the optimal weight is about or equal to 1, the optimal weight indicates that the overlay model is minimally or not contributing to the ensemble model predictions. Thus, the ensemble model should not be pushed to production and the overlay model should be trained again in a broader time frame that includes more recent data. If the optimal weight is about or equal to the starting weight value, the optimal weight indicates that the base model is minimally or not contributing to the ensemble model predictions. Thus, the base model may need replacement, including new model training, validation, and manual verification.

Stability can correspond to how stable a machine learning model is with respect to time. Stability can evaluate if a distribution of predictions from a previous machine learning model already in production is comparable to a distribution of predictions from the ensemble model. Stability can be determined by a population stability index (PSI) or a characteristic stability index (CSI), as examples.

Stability metrics can be domain specific. For example, in the spam detection domain, a difference of the total number of flagged entities by a previous model in production and the retrained ensemble model should be less than or equal to a threshold percentage, such as 10%. Flagged entities can correspond to an entity having a risk score that exceeds a decision threshold. As another example in the spam detection domain, a top cost-wise number of entities, such as 20, flagged by the previous model in production and the retrained ensemble model should not differ by more than a threshold percentage, such as 10%. Flagged entities can be sorted by cost in reverse order, where the first number of entities are the top cost-weighted entities. As yet another example in the spam detection domain, the dollar amount of ad revenue difference of flagged entities between the previous model in production and the retrained ensemble model should not differ by more than a threshold percentage, such as 15%. The above examples can be beneficial in the spam detection domain by avoiding situations where top entities by cost are flagged by the retrained model but not by the base model. These top entities by cost that get flagged by the retrained model but not by the base model can have a higher likelihood of being false positives, especially for some users in the spam detection domain that are less spam-prone.

If the plurality of metrics passes the validation, then the ensemble model can be pushed to production. For classification performance, the optimal weight should lay inside a range within the search interval. For stability metrics, differences between the previous model in production and the retrained ensemble model should be less than or equal to a percentage threshold.

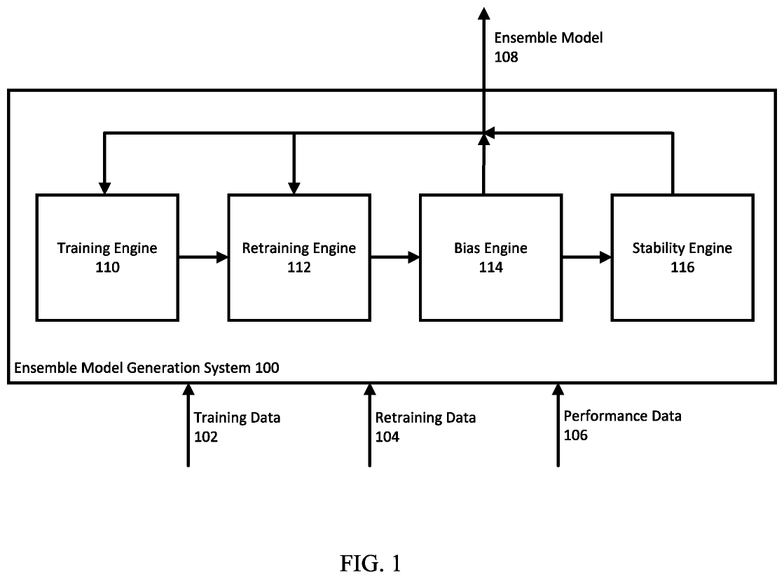

FIG. 1 depicts a block diagram of an example ensemble model generation system 100. The ensemble model generation system 100 can be configured to receive input data according to a user interface. For example, the ensemble model generation system 100 can receive the data as part of a call to an application programming interface (API) exposing the ensemble model generation system 100. The ensemble model generation system 100 can be implemented on one or more computing devices. Input to the ensemble model generation system 100 can be provided, for example, through a storage medium, including remote storage connected to the one or more computing devices over a network, or as input through a user interface on a client computing device coupled to the ensemble model generation system 100.

The ensemble model generation system 100 can be configured to receive training data 102 for generating a base model, retraining data 104 for generating an overlay model, and performance data 106 for determining an amount of bias to provide to the base model. The ensemble model generation system 100 can be configured to implement the techniques for generating an ensemble model having an amount of bias towards the base model, to be described further below.

The training data 102 can correspond to data for generating the base model. The training data 102 can be in any form suitable for training the base model, according to one of a variety of different learning techniques. Learning techniques for training the base model can include supervised learning, unsupervised learning, and semi-supervised learning techniques. For example, the training data 102 can include multiple training examples that can be received as input by the base model. The training examples can be labeled with a desired output for the base models when processing the labeled training examples. The label and the model output can be evaluated by evaluation metrics, which can be backpropagated through the base model to update weights for the base model. Training can correspond to a complete process of generating the base model that can include selecting of the most predictive signals, generating features of the signals, finding the best hyper-parameters, training to find the most optimal weights, and validating the base model performance on a test dataset. The features can be normalized, such as for gradient descent methods.

The retraining data 104 can correspond to data for generating the overlay model. The retraining data 104 can be derived from a newer dataset from a new time frame compared to the training data 102, which can be derived from an older dataset from an older time frame. The retraining data 104 can be in any form suitable for training the overlay model, according to one of a variety of different learning techniques. Learning techniques for training the overlay model can include supervised learning, unsupervised learning, and semi-supervised learning techniques. For example, the retraining data 104 can include multiple retraining examples that can be received as input by the overlay model. The retraining examples can be labeled with a desired output for the overlay models when processing the labeled training examples. The label and the model output can be evaluated by evaluation metrics, which can be backpropagated through the overlay model to update weights for the overlay model. Retraining can correspond to a slimmer process compared to training.

The performance data 106 can correspond to data for determining an amount of bias to provide to the base model. The performance data 106 can include data for classification performance related to how well an ensemble model can perform classification. A maximum classification performance of the ensemble model can correspond to an optimal amount of bias to give to the base model.

The ensemble model generation system 100 can be configured to output an ensemble model 108 with a determined amount of bias towards the base model based on the training data 102, retraining data 104, and performance data 106. The ensemble model 108 can be sent as an output, for example displayed on a user display. The ensemble model generation system 100 can be configured to provide the ensemble model 108 as a set of computer-readable instructions, such as one or more computer programs. A computer program can be written in any type of programming language, and according to any programming paradigm, e.g., declarative, procedural, assembly, object-oriented, data-oriented, functional, imperative, etc. A computer program can be written to perform one or more different functions and to operate within a computing environment, e.g., on a physical device, virtual machine, or across multiple devices. A computer program can also implement functionality described in this specification, for example, as performed by a system, engine, module, or model.

The ensemble model generation system 100 can include a training engine 110. The training engine 110 can generate the base model through a process involving selecting of the most predictive signals, generating features of the signals, finding the best hyper-parameters, training to find the most optimal weights, and validating the base model performance on a test dataset. The features can be normalized, such as for gradient descent methods.

Classification performance of the base model is expected to degrade over time due to change in underlying input data distributions. The base model can be monitored to ensure it is performance well enough to continue functioning. To improve model performance on new data, the base model can be retrained periodically, for example monthly or bi-monthly. The base model can be retrained at a frequency such that the new data does not diverge too much from the initial training data but still diverges enough that retraining would not be a waste of resources.

The ensemble model generation system 100 can include a retraining engine 112. The retraining engine 112 can generate the overlay model through a retraining process. Retraining should improve classification performance on more recent data without requiring manual verification. Retraining can be similar to training but omit signal selection to instead rely on the same signal selected during training. Retraining can also omit feature engineering and instead reuse the feature engineering decisions made during the training. Retraining can reduce hyper-parameter tuning as well and instead reuse a model architecture found optimal during training, though learning rate and optimization algorithms could be changed to achieve a better prediction stability.

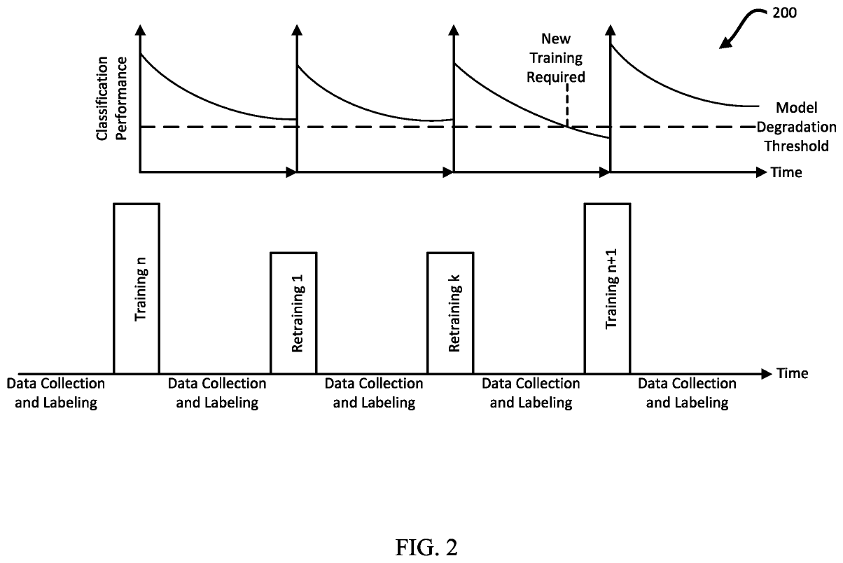

FIG. 2 depicts an example time diagram 200 of model training and retraining based on model classification performance degradation. After a training n, the model classification performance degrades with time. Therefore, the model is tuned up through several periodic cycles of model retraining, depicted by retraining 1 through k. While only two retraining blocks are depicted in FIG. 2 for simplicity, there can be any number of retraining cycles between training. Eventually the model performance becomes inadequate, requiring a new model to be generated through a training n+1. The model can become inadequate when its classification performance dips below a degradation threshold. Other triggers for training a new model can be adding or removing features or changing a training algorithm.

Referring back to the retraining engine 112 of FIG. 1, as part of the retraining to generate the overlay model, data from entities are used repeatedly at different times. Therefore, each example in the retraining data 104 can contain three parts: a key, features, and a label. To manage these examples and successfully generate an overlay model, these examples can have certain properties. First, entities can have a unique and stable key to be correctly used in multiple retraining runs and to avoid data contamination between models. Second, the label and features can have a particular temporal relationship. As the features for an example are generally aggregated, the data used for labeling should not overlap with the feature aggregation window. Third, to minimize feedback, an existing positive label for the entity should not be known during the feature aggregation window.

The examples used for retraining, test, and validation by the retraining engine 112 are specified by a key and a point in time. A collection of examples for a retraining run can correspond to a data epoch. Each epoch contains training, testing, and validation splits. Since retraining and validating occur on different epochs, the validation metrics should not be skewed by moving entities between splits from one epoch to the next. Thus, the splitting can be done deterministically in the key space. Additionally, the training split can be temporally separated from the testing and validation splits to further minimize the influence of actions taken during the training split impacting the testing split.

As the notion of risk is slightly different across different verticals, the retraining engine 112 can be agnostic about how risk is assessed for any particular entity. Generally, risk can correspond to the likelihood of future action and high-quality labels are created by a variety of manual and automated processes, so a temporal separation between feature extraction and label generation can capture this intuition.

A data epoch can correspond to the time window from the beginning of the training feature window to the testing label collection time. For each retraining run, the data epochs can be combined into a single coherent collection of examples on which to optimize the overlay model. This collection can contain data from the entire time since the last retraining. However, each entity key can transform over time, experiencing the following life cycle: birth—an entity produces traffic for the first time; detection-invalid traffic is detected from the entity; action—an entity is enforced in some way and the enforcement serves as a positive label, where this is now a positive example for training; and death or dormancy—an entity no longer produces traffic.

Each entity key can potentially produce both positive and negative examples. A rollup method can select the most recent available example for any entity. This prevents training multiple times on the same key and allows for the largest sample of positive examples since even filtered entities which no longer produce traffic will be included as long as that epoch has not been included in a previous retraining rollup.

The ensemble model generation system 100 can include a bias engine 114. The bias engine 114 can determine the amount of bias to provide to the base model. A retrained model can correspond to an ensemble of the base model and the overlay model. The base model can correspond to a fully trained, tuned, and manually reviewed model. The overlay model can correspond to a model trained on a newer dataset, where the newer dataset can be the same collection of signals as for the base model gathered during a more recent time frame.

For performing inference, the ensemble model predicted score can be computed as the following equation:

$$\\ \begin{matrix}{g}_{α} = ( 1 - α ) {x}_{i} + α {y}_{i} & ( 1 )\end{matrix}$$

where xᵢ and yᵢ are various support teams of the overlay model and base model for an entity, respectively, and α is a tunable model weight that can correspond to the amount of bias to provide to the base model.

The base model can remain in the ensemble model to leverage the manual review conducted during initial launch. When time for retraining comes, the overlay model can be replaced with a subsequent overlay model trained on a more recent epoch. The model weight can be automatically tuned via the bias engine 114 using a grid search based on classification performance from the classification performance data 106. Classification performance can be determined by area under the curve receiver operating characteristic (AUCROC), area under the curve precision recall (AUCPR), or F-score, as examples. Classification performance of the overlay model should be on par with the base model, but as long as the ensemble model has a higher classification performance than the base model or a previous model in production, the ensemble model can be output 108 from the ensemble model generation system 100 to be pushed to production.

The model weight corresponding to the optimal amount of bias given to the base model can be determined by determining a maximum classification performance of the ensemble model in a search interval from a starting weight value to 1 using a search method. Example search methods can include a grid search or a generic line search with step size ranging from 0.01 to 0.1, depending on the sensitivity of classification performance to the weight value. The starting weight value can control a minimum bias of the base model and can be larger than 0.5 to provide more bias towards the base model. This leverages the manual review from full training of the base model compared to the automatic validation from retraining of the overlay model. Thus, a more accurate ensemble model can be produced based on the benefits achieved from the full training of the base model, and the benefits achieved by the ensemble model trained on a newer dataset.

The model weight can indicate that the overlay model and the base model both significantly contribute to the ensemble model predictions when the model weight is within a range within the search interval and is less than 1, for example within a range of 0.55 to 0.95. Both models significantly contributing can indicate that the ensemble model is truly outputting predictions that are a combination of the predictions from the overlay model and base model. Both models can significantly contribute when the overlay model and base model each contribute above a respective threshold amount such that the model weight is greater than the starting weight value but less than 1. When both the overlay model and base model significantly contribute to the ensemble model, the ensemble model can be output 108 as a candidate to be pushed to production.

The model weight can indicate that the overlay model is minimally or not contributing to the ensemble model predictions when the model weight is about or equal to 1. The overlay model minimally or not contributing can indicate that the ensemble model is essentially the base model. The overlay model can be not significantly contributing when the overlay model contributes below a threshold amount. When the overlay model is minimally or not contributing, the overlay model should be trained again via the retraining engine 112 using a broader epoch to include more recent data.

The model weight can indicate the base model is minimally or not contributing to the ensemble model predictions when the model weight is about or equal to the starting weight value. The base model minimally or not contributing can indicate the ensemble model is essentially the overlay model. The base model can be not significantly contributing when the base model contributes below a threshold amount. When the base model is minimally or not contributing, the base model may need to be replaced via the training engine 110, including new model training, validation, and manual verification.

The ensemble model generation system 100 can include a stability engine 116. The stability engine 116 can determine the stability of the ensemble model. Stability can correspond to how stable a machine learning model is with respect to time. The stability engine 116 can evaluate if a distribution of predictions from a previous ensemble model already in production is comparable to a distribution of predictions from the current ensemble model being output 108. Stability can be determined by a population stability index (PSI) or a characteristic stability index (CSI), as examples.

To improve stability and counter feedback loops, the stability engine 116 can implement label augmentation. A previous ensemble model is used to produce additional positive labels for the newer datasets. By leveraging the previous ensemble model, information about currently detected patterns and previous optimizations can be transferred to the ensemble model being output 108. This can purposefully bias retraining metrics towards existing assessments and penalizes overlay models that drift too far from the base model during retraining. The set of example labels can be determined by the following equation:

$${L}_{aug} = L ⋃ \{ e \vert {g}_{α} ( e ) > τ \} \qquad ( 2 )$$

where τ is a calibrated threshold and e is an entity. Example calibrated thresholds can be 0.75, 0.9, or 0.99, but can also be lower values such as 0.01 for rare event predictions. Adding samples with predictions above the calibrated threshold to subsequent training sets can increase the likelihood that a newer ensemble model will behave similarly to a previous ensemble model.

When an ensemble model gets output 108 to be pushed to production, it becomes a subject of production monitoring. Classification performance can be monitored to determine if the ensemble model should be retrained by the retraining engine 112 or fully trained by the training engine 110.

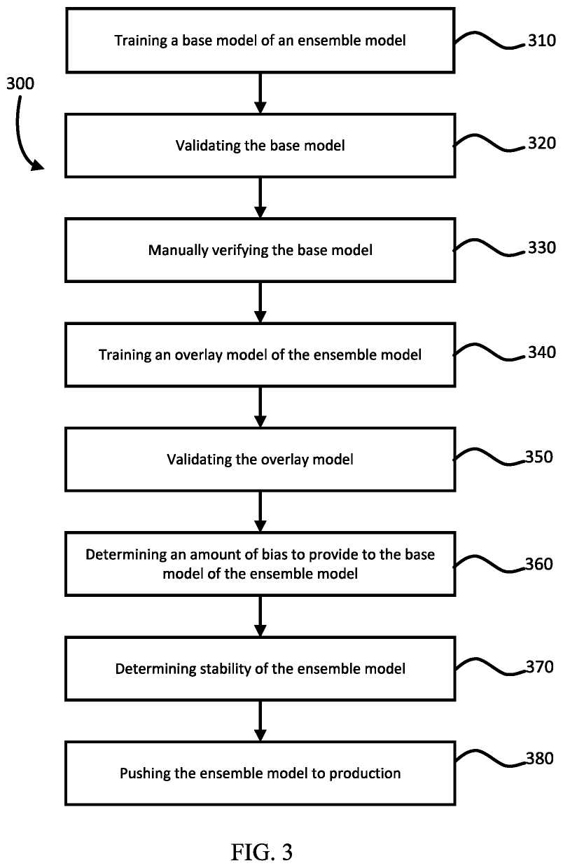

FIG. 3 depicts a flow diagram of an example process 300 for retraining a machine learning model using an ensemble model. The example process 300 can be performed on a system of one or more processors in one or more locations, such as the ensemble model generation system 100 of FIG. 1.

As shown in block 310, the ensemble model generation system 100 can train a base model of an ensemble model. The base model can be trained on an older dataset from an older time frame to determine optimal weights for the base model. As shown in block 320, the ensemble model generation system 100 can automatically validate the base model of the ensemble model using test data from the older dataset. Automatic validation can include rules to ensure the model is performing as intended, such as whether overall model accuracy is above a threshold. As shown in block 330, the base model can be manually verified. Manual verification can include balancing factors, such as sacrificing an accuracy percentage in one geographic region to obtain a higher accuracy percentage overall.

As shown in block 340, after a period of time, the ensemble model generation system 100 can train an overlay model of the ensemble model. The overlay model can be trained on a newer dataset from a newer time frame compared to the older dataset to determine optimal weights for the overlay model. As shown in block 350, the ensemble model generation system can automatically validate the overlay model. For the overlay model, the newer dataset can be split into training and test datasets. The overlay model can be trained with the training dataset and automatically validated by computing a plurality of metrics on the test dataset. The plurality of metrics can include classification performance and stability. Classification performance can correspond to how well a machine learning model performs classification using a test dataset. Classification performance can be determined by area under the curve receiver operating characteristic (AUCROC), area under the curve precision recall (AUCPR), or F-score, as examples. Stability can correspond to how stable a machine learning model is with respect to time. Stability can evaluate if a distribution of predictions from a previous machine learning model already in production is comparable to a distribution of predictions from the ensemble model. Stability can be determined by a population stability index (PSI) or a characteristic stability index (CSI), as examples.

As shown in block 360, the ensemble model generation system 100 can determine an amount of bias to provide to the base model of the ensemble model based on classification performance. The maximum classification performance of the ensemble model in a search interval from a starting weight value to 1 can determine a model weight corresponding to the optimal amount of bias given to the base model. The starting weight value can be larger than 0.5 to provide more bias towards the base model. If the model weight is within a range within the search interval and is less than 1, the model weight can indicate that the overlay model and base models both significantly contribute to the ensemble model predictions. Thus, the ensemble model can be a good candidate to be pushed to production. If the optimal weight is about or equal to 1, the optimal weight indicates that the overlay model is minimally or not contributing to the ensemble model predictions. Thus, the ensemble model should not be pushed to production and the overlay model should be trained again in a broader time frame that includes more recent data. If the optimal weight is about or equal to the starting weight value, the optimal weight indicates that the base model is minimally or not contributing to the ensemble model predictions. Thus, the base model may need replacement, including new model training, validation, and manual verification.

As shown in block 370, the ensemble model generation system 100 can determine a stability of the ensemble model. Classification performance of the overlay model should be on par with the base model, for example within a threshold percentage, as the overlay model should not diverge too far in classification performance from the base model. Further, classification performance of the ensemble model should be on par with previously in production ensemble models, for example within a threshold percentage.

As shown in block 380, the ensemble model generation system 100 can push the ensemble model to production when the model weight is within a sufficient range between the starting weight and 1 and/or the ensemble model is sufficiently on par with previously in production ensemble models. Being pushed to production can include being deployed for real-world use as a web service, as offline batch prediction, or as embedded on edge/mobile devices.

Retraining a machine learning model via an ensemble model can be implemented in a spam detection domain to protect ad revenue by identifying invalid traffic and filtering it out. Invalid traffic can include bot traffic, pay-to-click traffic, or other kinds of abuse. Spam detection can identify publishers of invalid traffic as fraudulent, so that they can be terminated from the ad network or have ads stopped being served to them. Spam detection can also identify publishers of a mixture of invalid and organic traffic, so that the invalid traffic can be filtered out while the organic traffic can be allowed. In this way, the disclosed methods and systems for retraining a machine learning model have a technical effect of producing a more accurate machine learning model which can be more effective at filtering fraudulent activity in a spam detection context.

The ensemble model retraining can also be implemented in other domains where errors can have larger consequences, model validation involves manual reviews, and/or data fluctuates over time. In other words, the disclosed methods and systems for retraining a machine learning model can produce more accurate machine learning models that are used in a variety of different technical applications. For example, other domains can include identifying financial fraud, monitoring safety of engineering constructions, and computer security for sensitive enterprises.

For identifying financial fraud, data can fluctuate over time as fraudulent actors generate novel fraud techniques or resurrect older fraud techniques to evade detection. Further, real world consequences of false positives and false negatives can be costly both in terms of monetary value and user satisfaction, so classification accuracy as data changes is especially important. Similarly for monitoring safety of engineering constructions, classification accuracy as data changes is vital to avoid the costly real world consequences of false positives and false negatives. For computer security, bad actors can adapt to defenses to evade detection and false positives and false negatives can lead to costly real world consequences as well.

For the spam detection domain, the ensemble model generation system 100 can train, validate, and manually verify a base model to differentiate between valid and invalid traffic. After a period of time, the base model can degrade in its ability to distinguish between valid and invalid traffic for spam detection. The ensemble model generation system 100 can train and automatically validate an overlay model to more accurately differentiate between valid and invalid traffic. The overlay model can be trained and validated on newer data compared to the base model.

The ensemble model can include a combination of the ability of the base model and overlay model to differentiate between valid and invalid traffic, with a determined amount of bias provided to the base model. The ensemble model generation system 100 can determine that a model weight can correspond to the amount of bias. The model weight can be determined by a maximum ability of the ensemble model to differentiate valid and invalid traffic in a search interval from an example starting weight value of 0.7 to 1 for the spam detection domain. A search method, such as a grid search or line search with example step 0.05 can be used to determine the maximum ability in the search interval.

If the model weight is within a range 0.75 to 0.95, the model weight can indicate that the overlay model and base models both significantly contribute to the ability of the ensemble model to differentiate valid and invalid traffic. Thus, the ensemble model can be a good candidate to be pushed to production for spam detection. If the model weight is within a range of 0.95 to 1, the optimal weight can indicate that the overlay model is minimally or not contributing to the ability of the ensemble model to differentiate valid and invalid traffic. Thus, the ensemble model should not be pushed to production and the overlay model should be trained again in a broader time frame that includes more recent data. If the model weight is within a range of 0.7 to 0.75, the model weight can indicate that the base model is minimally or not contributing to the ability of the ensemble model to differentiate valid and invalid traffic. Thus, the base model may need replacement, including new model training, validation, and manual verification. It should be noted the ranges described herein are exemplary and, so long as the model weight is within a range between the starting value and 1 and performance metrics of the ensemble model are improved compared to the base model or overlay model on their own, the ensemble model can be a candidate for pushing to production.

The ensemble model generation system 100 can also determine if the ensemble model is sufficiently stable compared to previously-in-production ensemble models. For example, a difference of the total number of invalid traffic entities by a previously-in-production ensemble model and the current ensemble model should be less than or equal to a threshold percentage, such as 5%, 10%, or 15%. Invalid traffic entities can correspond to an entity having a risk score that exceeds a decision threshold. As another example, a top cost-wise number of entities, such as 5, 10, or 20, flagged by the previously-in-production ensemble model and the current ensemble model should not differ by more than a threshold percentage, such as 10%. Flagged entities can be sorted by cost in reverse order, where the first number of entities are the top cost-weighted entities. As yet another example, the dollar amount of ad revenue difference of invalid traffic entities between the previously-in-production ensemble model and the current ensemble model should not differ by more than a threshold percentage, such as 10%, 15%, or 20%. The above examples can avoid situations where top entities by cost are flagged by the retrained model but not by the base model because those top entities by cost have a higher likelihood of being false positives.

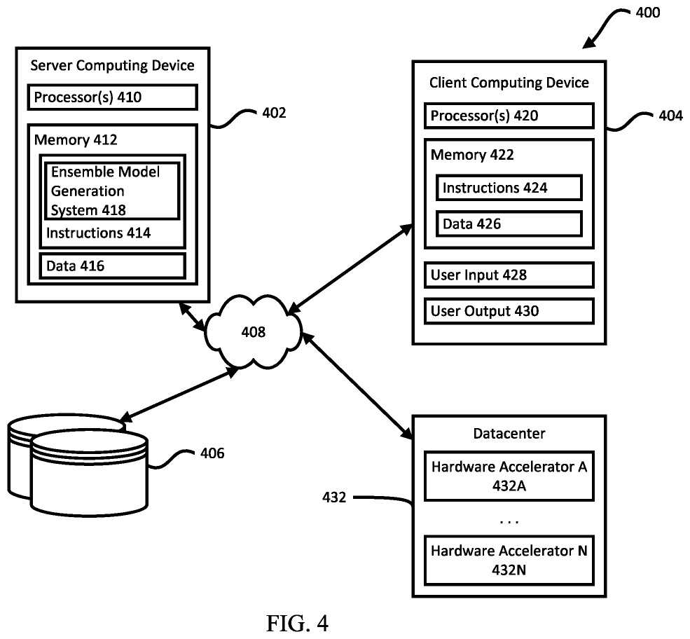

FIG. 4 depicts a block diagram of an example environment 400 for retraining machine learning models using an ensemble model. The environment 400 can be implemented on one or more devices having one or more processors in one or more locations, such as in server computing device 402. Client computing device 404 and the server computing device 402 can be communicatively coupled to one or more storage devices 406 over a network 408. The storage devices 406 can be a combination of volatile and non-volatile memory and can be at the same or different physical locations than the computing devices 402, 404. For example, the storage devices 406 can include any type of computer readable medium capable of storing information, such as a hard-drive, solid state drive, tape drive, optical storage, memory card, ROM, RAM, DVD, CD-ROM, write-capable, and read-only memories. The computer-readable medium is optionally non-transitory.

The server computing device 402 can include one or more processors 410 and memory 412. The memory 412 can store information accessible by the processors 410, including instructions 414 that can be executed by the processors 410. The memory 412 can also include data 416 that can be retrieved, manipulated, or stored by the processors 410. The memory 412 can be a type of computer readable medium, which is optionally non-transitory, capable of storing information accessible by the processors 410, such as volatile and non-volatile memory. The processors 410 can include one or more central processing units (CPUs), graphic processing units (GPUs), field-programmable gate arrays (FPGAs), and/or application-specific integrated circuits (ASICs), such as tensor processing units (TPUs).

The instructions 414 can include one or more instructions that when executed by the processors 410, causes the one or more processors to perform actions defined by the instructions. The instructions 414 can be stored in object code format for direct processing by the processors 410, or in other formats including interpretable scripts or collections of independent source code modules that are interpreted on demand or compiled in advance. The instructions 414 can include instructions for implementing an ensemble model generation system 418, which can correspond to the ensemble model generation system 100 of FIG. 1. The ensemble model generation system 418 can be executed using the processors 410, and/or using other processors remotely located from the server computing device 402.

The data 416 can be retrieved, stored, or modified by the processors 410 in accordance with the instructions 414. The data 416 can be stored in computer registers, in a relational or non-relational database as a table having a plurality of different fields and records, or as JSON, YAML, proto, or XML documents. The data 416 can also be formatted in a computer-readable format such as, but not limited to, binary values, ASCII or Unicode. Moreover, the data 416 can include information sufficient to identify relevant information, such as numbers, descriptive text, proprietary codes, pointers, references to data stored in other memories, including other network locations, or information that is used by a function to calculate relevant data.

The client computing device 404 can also be configured similarly to the server computing device 402, with one or more processors 420, memory 422, instructions 424, and data 426. The client computing device 404 can also include a user input 428, and a user output 430. The user input 428 can include any appropriate mechanism or technique for receiving input from a user, such as keyboard, mouse, mechanical actuators, soft actuators, touchscreens, microphones, and sensors.

The server computing device 402 can be configured to transmit data to the client computing device 404, and the client computing device 404 can be configured to display at least a portion of the received data on a display implemented as part of the user output 430. The user output 430 can also be used for displaying an interface between the client computing device 404 and the server computing device 402. The user output 430 can alternatively or additionally include one or more speakers, transducers or other audio outputs, a haptic interface or other tactile feedback that provides non-visual and non-audible information to the platform user of the client computing device 404.

Although FIG. 4 illustrates the processors 410, 420 and the memories 412, 422 as being within the computing devices 402, 404, components described herein can include multiple processors and memories that can operate in different physical locations and not within the same computing device. For example, some of the instructions 414, 424 and the data 416, 426 can be stored on a removable SD card and others within a read-only computer chip. Some or all of the instructions and data can be stored in a location physically remote from, yet still accessible by, the processors 410, 420. Similarly, the processors 410, 420 can include a collection of processors that can perform concurrent and/or sequential operation. The computing devices 402, 404 can each include one or more internal clocks providing timing information, which can be used for time measurement for operations and programs run by the computing devices 402, 404.

The server computing device 402 can be connected over the network 408 to a datacenter 432 housing hardware accelerators 432A-N. The datacenter 432 can be one of multiple datacenters or other facilities in which various types of computing devices, such as hardware accelerators, are located. The computing resources housed in the datacenter 432 can be specified for deploying ensemble models, as described herein.

The server computing device 402 can be configured to receive requests to process data 426 from the client computing device 404 on computing resources in the datacenter 432. For example, the environment 400 can be part of a computing platform configured to provide a variety of services to users, through various user interfaces and/or APIs exposing the platform services. One or more services can be a machine learning framework or a set of tools for generating and/or utilizing spam detection neural networks or other machine learning spam detection models and distributing spam detection results. The client computing device 404 can receive and transmit data for generating an ensemble model for spam detection. The ensemble model generation system 418 can receive the data and in response generate one or more ensemble models for spam detection.

As other examples of potential services provided by a platform implementing the environment 400, the server computing device 402 can maintain a variety of ensemble models in accordance with different spam detection policies or other implementations. For example, the server computing device 402 can maintain different families for deploying neural networks on the various types of TPUs and/or GPUs housed in the datacenter 432 or otherwise available for processing.

The devices 402, 404 and the datacenter 432 can be capable of direct and indirect communication over the network 408. For example, using a network socket, the client computing device 404 can connect to a service operating in the datacenter 432 through an Internet protocol. The devices 402, 404 can set up listening sockets that may accept an initiating connection for sending and receiving information. The network 408 itself can include various configurations and protocols including the Internet, World Wide Web, intranets, virtual private networks, wide area networks, local networks, and private networks using communication protocols proprietary to one or more companies. The network 408 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 408, in addition or alternatively, can also support wired connections between the devices 402, 404 and the datacenter 432, including over various types of Ethernet connection.

Although a single server computing device 402, client computing device 404, and datacenter 432 are shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing neural networks, and any combination thereof.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A computer-implemented method for retraining a machine learning model, comprising:
generating, with one or more processors, an ensemble model, the ensemble model comprising a base model and an overlay model, wherein the base model has been trained using a first dataset;
training, with the one or more processors, the overlay model with a training dataset, wherein the training dataset is a first subset of a second dataset that is newer than the first dataset;
validating, with the one or more processors, the trained overlay model with a test dataset using a plurality of metrics, wherein the test dataset is a second subset of the second dataset;
determining, with the one or more processors and based on the plurality of metrics, an amount of bias to provide to the base model compared to the overlay model when performing predictions using the ensemble model; and
performing, with the one or more processors, a prediction using the ensemble model based on a combination of a prediction from the base model and a prediction from the overlay model with the determined amount of bias towards the prediction from the base model.

2. The computer-implemented method of claim 1, further comprising training, with the one or more processors, the base model with a base model training dataset, wherein the base model training dataset is a first subset of the first dataset.

3. The computer-implemented method of claim 2, further comprising:
validating, with the one or more processors, the base model with a base model test dataset, wherein the base model test dataset is a second subset of the first dataset; and
manually verifying the base model with the base model test dataset of the first dataset.

4. The computer-implemented method of claim 1, wherein the plurality of metrics comprises classification performance.

5. The computer-implemented method of claim 4, wherein determining the amount of bias further comprises determining a maximum classification performance of the ensemble model in a search interval using a search method.

6. The computer-implemented method of claim 5, wherein the search interval comprises a starting weight value to a weight value of 1, the starting weight value being greater than 0.5.

7. The computer-implemented method of claim 5, further comprising determining, with the one or more processors, that the determined amount of bias is within a range within the search interval where both the overlay model and base model each contribute above a threshold amount to the ensemble model predictions.

8. The computer-implemented method of claim 5, further comprising:
determining, with the one or more processors, that the determined amount of bias is within a range within the search interval where the overlay model contributes below a threshold amount to the ensemble model predictions; and
retraining, with the one or more processors, the overlay model with the second dataset.

9. The computer-implemented method of claim 5, further comprising:
determining, with the one or more processors, that the determined amount of bias is within a range within the search interval where the base model contributes below a threshold amount to the ensemble model predictions; and
replacing, with the one or more processors, the base model.

10. The computer-implemented method of claim 1, wherein the plurality of metrics comprises stability.

11. The computer-implemented method of claim 10, further comprising determining, with the one or more processors, ensemble model predictions are within a threshold compared to predictions from a previous model such that the ensemble model is pushed to production.

12. A system comprising:
one or more processors; and
one or more storage devices coupled to the one or more processors and storing instructions that, when executed by the one or more processors, cause the one or more processors to perform operations for retraining a machine learning model, the operations comprising:
generating an ensemble model, the ensemble model comprising a base model and an overlay model, wherein the base model has been trained using a first dataset;
training the overlay model with a training dataset, wherein the training dataset is a first subset of a second dataset that is newer than the first dataset;
validating the trained overlay model with a test dataset using a plurality of metrics, wherein the test dataset is a second subset of the second dataset;
determining, based on the plurality of metrics, an amount of bias to provide to the base model compared to the overlay model when performing predictions using the ensemble model; and
performing a prediction using the ensemble model based on a combination of a prediction from the base model and a prediction from the overlay model with the determined amount of bias towards the prediction from the base model.

13. The system of claim 12, wherein the operations further comprise:
training the base model with a base model training dataset, wherein the base model training dataset is a first subset of the first dataset;
validating the base model with a base model test dataset, wherein the base model test dataset is a second subset of the first dataset; and
manually verifying the base model with the base model test dataset of the first dataset.

14. (canceled)

15. The system of claim 12, wherein the plurality of metrics comprises classification performance.

16. The system of claim 15, wherein determining the amount of bias further comprises determining a maximum classification performance of the ensemble model in a search interval using a search method.

17. (canceled)

18. The system of claim 16, wherein the operations further comprise determining that the determined amount of bias is within a range within the search interval where both the overlay model and base model each contribute above a threshold amount to the ensemble model predictions.

19. The system of claim 16, wherein the operations further comprise:
determining that the determined amount of bias is within a range within the search interval where the overlay model contributes below a threshold amount to the ensemble model predictions; and
retraining the overlay model with the second dataset.

20. The system of claim 16, wherein the operations further comprise:
determining that the determined amount of bias is within a range within the search interval where the base model contributes below a threshold amount to the ensemble model predictions; and
replacing the base model.

21. (canceled)

22. The system of claim 21, wherein:
the plurality of metrics comprises stability; and
the operations further comprise determining ensemble model predictions are within a threshold compared to predictions from a previous model such that the ensemble model is pushed to production.

23. A computer readable medium for storing instructions that, when executed by one or more processors, cause the one or more processors to perform operations for retraining a machine learning model, the operations comprising:
generating an ensemble model, the ensemble model comprising a base model and an overlay model, wherein the base model has been trained using a first dataset;
training the overlay model with a training dataset, wherein the training dataset is a first subset of a second dataset that is newer than the first dataset;
validating the trained overlay model with a test dataset using a plurality of metrics, wherein the test dataset is a second subset of the second dataset;
determining, based on the plurality of metrics, an amount of bias to provide to the base model compared to the overlay model when performing predictions using the ensemble model; and
performing a prediction using the ensemble model based on a combination of a prediction from the base model and a prediction from the overlay model with the determined amount of bias towards the prediction from the base model.

24. (canceled)

25. (canceled)

26. (canceled)

27. (canceled)

28. (canceled)

29. (canceled)

30. (canceled)

31. (canceled)

32. (canceled)

33. (canceled)
